(19) United States
(12) Patent Application Publication
(10) Pub. No.: US 2025/0164604 A1
(43) Pub. Date: May 22, 2025

(54) High Resolution Tracking in Millimeter Wave Signal Processing

(71) Applicant: MMRFIC Technology Private Limited, Bangalore (IN)

(72) Inventors: Ganesan Thiagarajan, Bengaluru (IN); Sanjeev Gurugopinath, Bengaluru (IN)

(73) Assignee: MMRFIC Technology Private Limited, Bangalore (IN)

(21) Appl. No.: 18/942,963

(22) Filed: Nov. 11, 2024

(30) Foreign Application Priority Data
Nov. 22, 2023 (IN) 202341067112

(51) Int. Cl. G01S 7/35; G01S 7/41

(52) U.S. Cl. CPC G01S 7/352; G01S 7/411

(57) ABSTRACT

According to an aspect, a millimeter wave signal processing system comprising, a millimeter wave signal carrying a set of data represented in a polar form, a tracking filter configured to provide a set of variables in the polar form that is determined from the set of data and a system model that maintain linear relation with the set of variable and the set of data. According to another aspect, the millimeter wave is a radar signal reflected from an object, the set of data is a measurement of an object in motion comprising a range, an angle, and a radial velocity, and the set of variables comprising a range, an angle, a radial velocity, and tangential velocity. Wherein the set of variables comprising a radial acceleration and a tangential acceleration.

### CROSS REFERENCES TO RELATED APPLICATIONS

This application claims priority from Indian Patent application No.: 202341067112 filed on Nov. 22, 2023 which is incorporated herein in its entirety by reference

### BACKGROUND

### Field of Invention

Embodiments of the present disclosure relate to electronic communication system and more particularly relate to system, method and apparatus for high resolution tracking in millimeter wave signal processing.

### RELATED ART

In an electronic system that is adopted for applications such as wireless communication, object detection etc., a millimeter wave signal is employed due to the advantages such as reduction in system size and enhanced bandwidth. The electronic system that processes the millimeter wave signal is generally referred to as millimeter wave signal processing system. As an example, the wireless communication system adopted 4G and 5G standards processes millimeter wave signals. Similarly, object tracking radar systems adopted for high-density vehicular traffic management, unmanned vehicle navigation, etc., also employ millimeter wave signal. These millimeter wave signals often carry information that is required to be extracted more accurately with less complexity. In certain electronics systems, the millimeter signals are processed and desired information is extracted. For example, as in millimeter wave radar systems, the millimeter waves reflected from object/moving object is processed and the range, velocity and angle (of arrival) are extracted by processing the received signal (as is well known in the art). Similarly in case of the 4G and 5G communication systems, signal processing operations perform beamforming with phased array antenna systems to focus the wireless signal in a chosen direction. Accordingly, the information is extracted from the signal to determine the direction (beamforming) of transmission/arrival of the signal.

Tracking often refers to estimating and adjusting the received information based on certain criteria and the prior information. As is well known in the art, tracking (also referred to signal tracking) reduces the effect of noise contributed by the communication channel and the processing electronics. In other words, the signals are subjected to (adaptive) filtering to eliminate/reduce the effect of the noise during the signal processing. For example, in case of a Geographical Positioning System, a determined latitude and longitude may be filtered to align with the road contour for vehicle tracking application. In a similar way, the Radar data comprising range, velocity and angle of arrival received from the radar sensor may be subjected to adaptive filtering operation to eliminate or confine the sensor data within a known field of operation.

As is well known, Kalman filter is implemented for tracking purposes. The Kalman filter for being a linear filter, for its scalability of number of variables and inputs (parameters), for its high performance etc., is widely implemented as tracking filter in the signal processing. However, in certain applications Kalman filter may not be readily employed when one of the sensor inputs, system parameter (state-space model or system model) and the state variables are represented in different domain. For example, as in the Radar tracking, the sensor data (Input signal) is in the polar form and the state variables (velocity, distance or acceleration) are in the Cartesian form. Accordingly, the measurement (State) variables are converted to Cartesian coordinate and subsequently, the relationship between the measurement variables and state variables are linearised (approximated) for filtering, like in Extended Kalman filters, for example.

However, first of all, such approximation introduces error and secondly it also introduces additional hardware/processing power, thereby enhancing the cost and size of the system. More particularly, in case of millimeter wave signal processing such error may not be acceptable thereby rendering adoption of conventional tracking filter not a feasible option.

### SUMMARY

According to an aspect, a millimeter wave signal processing system comprising, a millimeter wave signal carrying a set of data represented in a polar form, a tracking filter configured to provide a set of variables in the polar form that is determined from the set of data and a system model that maintain linear relation with the set of variable and the set of data.

According to another aspect, the millimeter wave is a radar signal reflected from an object, the set of data is a measurement of an object in motion comprising a range, an angle, and a radial velocity, and the set of variables comprising a range, an angle, a radial velocity, and tangential velocity. Wherein the set of variables further comprising a radial acceleration and a tangential acceleration and the system model comprising a state transition vector and measurement vector.

According to another aspect, the predictor and the estimator are configured to predict a next set of values from a previous set of values of the set of variables using relation:

$$[ \begin{matrix}r ( k + 1 ) \\ θ ( k + 1 ) \\ {r}^{′} ( k + 1 ) \\ {θ}^{′} ( k + 1 )\end{matrix} ] = [ \begin{matrix}1 & 0 & Δ t & 0 \\ 0 & 1 & 0 & Δ t \\ 0 & 0 & 1 & 0 \\ 0 & 0 & 0 & ( 1 - Δ t \frac{{r}^{′} ( k )}{r ( k )} )\end{matrix} ] [ \begin{matrix}r ( k ) \\ θ ( k ) \\ {r}^{′} ( k ) \\ {θ}^{′} ( k )\end{matrix} ] + [ \begin{matrix}\frac{Δ {t}^{2}}{2} & 0 \\ 0 & 0 \\ Δ t & 0 \\ 0 & \frac{Δ t}{r ( k )}\end{matrix} ] [ \begin{matrix}{r}^{″} ( k \\ {v}_{θ}^{′} ( k )\end{matrix} ]$$

wherein r(k) and r′(k) representing a motion vector in radial direction with r(k) representing the radial distance and r′(k) representing the velocity in the radial direction (radial velocity), θ(k) and θ′(k) representing a motion vector in tangential direction with θ(k) representing the azimuth radial angle and θ′(k) representing the velocity in the tangential direction (tangential velocity), Δt representing the time difference between the current and previous time instances.

### BRIEF DESCRIPTION OF DRA WINGS

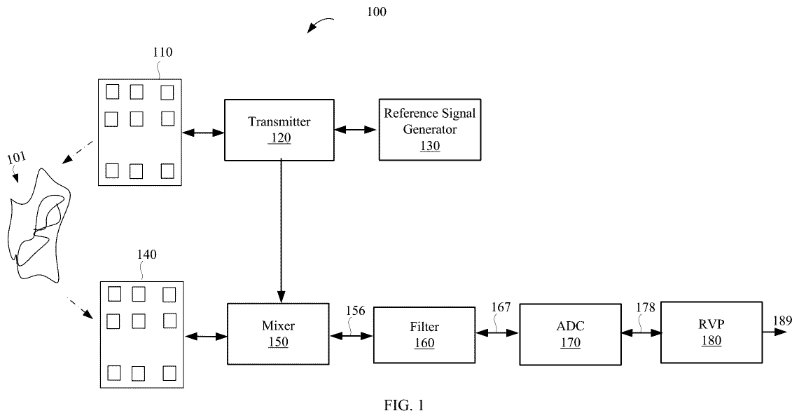

FIG. 1 is an example system/environment in which several aspect of the present invention may be seen.

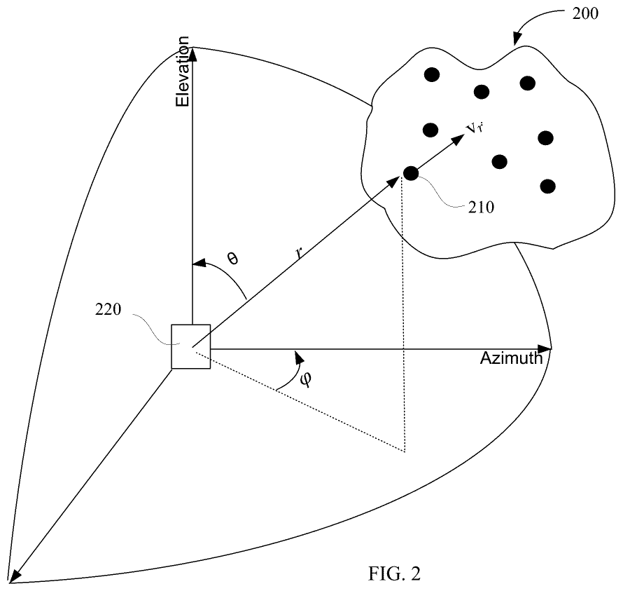

FIG. 2 illustrates the example range, velocity and the angle/position provided by the RVP.

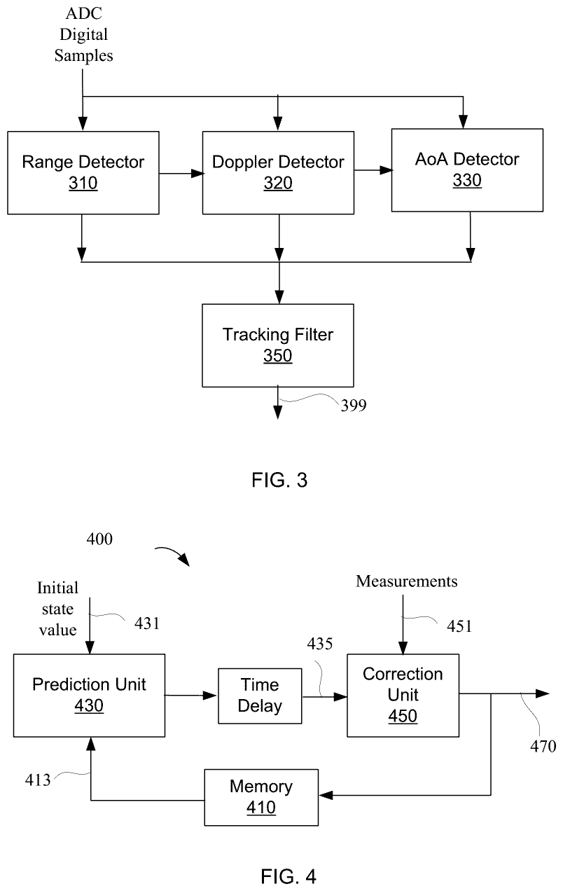

FIG. 3 is a block diagram illustrating the manner in which a tracking filter may be implemented in an embodiment.

FIG. 4 is a block diagram illustrating the tracking filter in an embodiment.

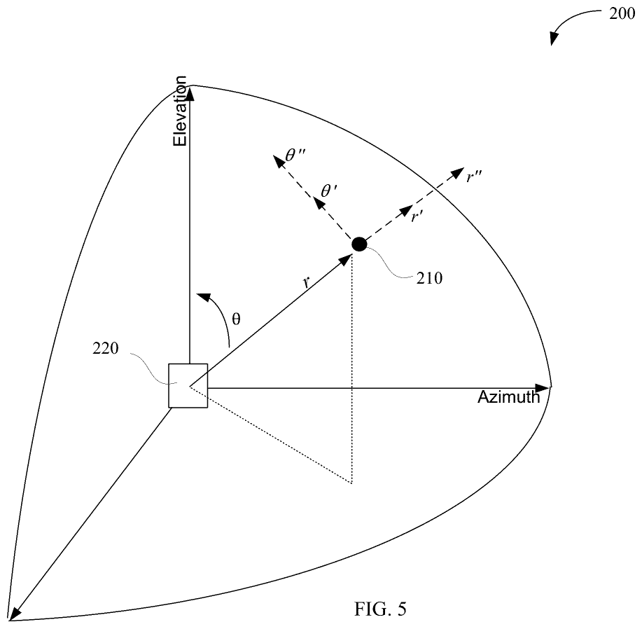

FIG. 5 illustrates the state variable provided by the estimator 450 for the measurement received in polar coordinates.

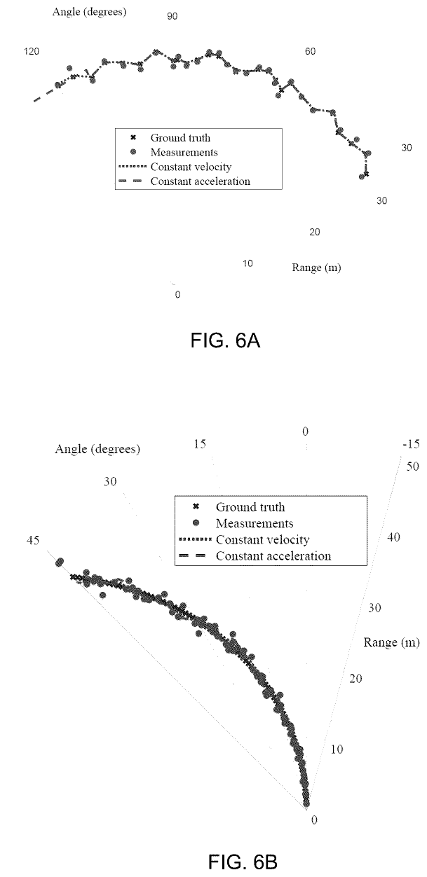

FIGS. 6A and 6B illustrates the performance of the filter 400 in an example embodiment.

### DETAILED DESCRIPTION OF THE PREFERRED EXAMPLES

FIG. 1 is an example system/environment in which several aspect of the present invention may be seen. The example system is a radar transceiver operative with millimetre wave signal for object detection and is so chosen merely for illustration. The radar transceiver 100 is shown comprising transmitting antenna 110, transmitter block 120, reference (radar) signal generator 130, receiving antenna array 140, mixer 150, filter 160, analog to digital convertor (ADC) 170 and Range Velocity and Position extractor (RVP) 180. Each element is described in further detail below.

In one embodiment, a radar signal generator 130 generates the radar signal and provides the same to the transmitter 120. The radar signal may be sequence of pulses as in pulsed radar and/or a chirp signal (a signal that is continuously varying in frequency) as in FMCW radar, for example. The radar signal may be a millimetre wave signal providing higher bandwidth for detection of objects that are very close to each other or determine the parameters of the objects with enhanced precession.

The transmitter 120 arranges/selects the transmitting antennas for transmitting the radar signal and provides the same to the transmitting antenna array 110 for transmission. The receiving antenna array 140 receives reflected radar signal (that is the radar signal reflected from plurality of objects 101).

The Mixer 150 mixes radar signal received on receiving antenna array 140 with a reference signal to generate an intermediate frequency signal (IF signal/base band signal). The intermediate frequency signal is provided on path 156 to filter 160. The filter 260 passes the IF signal received from the mixer attenuating the frequency components that are outside the band of interest (such as various harmonics).

The ADC 170 converts IF signal received on path 167 (analog IF signal) to digital IF signals. The ADC 170 may sample the analog IF signal at a sampling frequency Fs, and may generate a samples of the IF signal and convert each sample value to a bit sequence or binary value. The digitised samples of IF signal (digital IF signal) is provided for further processing on path 178 to RVP 180.

The Range Velocity and Position extractor (RVP) 180 is configured to determine/extract the range, the velocity/relative velocity and angle/position of the object from the digital samples received on the path 178. In one embodiment, the RVP 180 provides more accurate range, velocity and position by employing a tracking filter that tracks the received data (reflection signal) from the objects to provide more accurate RVP. In one embodiment the RVP 180 provides the range, velocity and the position of the object in polar coordinate.

FIG. 2 illustrates the example range, velocity and the angle/position provided by the RVP 180. As shown there, each vector point 210 is represented by its range (r), azimuth angle (φ)/elevation angle θ, and radial velocity (vᵣ) from the antenna 220. The group of vector points is shown forming a point cloud 200 representing extensive array of measurements (in certain instances, thousands per frame) yielding from multiple reflections from real-life targets. Each measurement vector signifies a reflection point, denoting range, angle, and radial velocity. In one embodiment, the RVP 180 employ tracking filter to localize the point cloud for any application to utilise the measurement. For example, tracking filter may be configured to receiving point cloud data (200), performing target classification and localization, and delivering the results (a list of confirmed targets) to a display unit. As a result, the tracking filter may provide output that consists of a set of trackable objects with distinct properties (such as range, angle, velocity, target tracking score, etc.) that any display unit (any application or utility) may utilize as the case may be. Further, the output of the tracking filter may be provide as a feedback for selecting valid ranges for determining the other parameters such as velocity and angle/direction.

FIG. 3 is a block diagram illustrating the manner in which a tracking filter may be implemented in an embodiment. The block diagram is shown comprising range detector 310, Doppler detector 320, AoA detector 330, and tracking filter 350. In that, the elements 310, 320 and 330 may be implemented as part of the RVP 180 with tracking filter 350 interfaced to RVP 180. As an alternative the tracking filter may be integrated within RVP 180 to provide the filtered RVP output. Each element is further described below.

The range detector 310 is shown receiving the digital samples (from the ADC) of the reflected signal received on each antenna elements. The range detector may determine the ranges of the multiple objects or point of reflections (as shown in the FIG. 2) by performing Fast Fourier Transformation (FFT) across a fixed set of samples (samples derived from one chirp, for example) or on the sequence of data/digital samples. The range detector 310 may perform any other known techniques to generate the range bins (as is well known in the art) representing the radial distance from the point of reflection and the receiver (antenna).

The Doppler detector 320 is shown receiving the range bins from the range detector. The Doppler detector may determine the relative velocity of the objects by performing FFT across the chirps/time frame for the Range bins determined. For example, the Doppler detector may determine the relative velocity (also referred to as Doppler) by performing FFT on the corresponding range bins (samples/range) over multiple chirps. The Doppler detector 320 may perform any other known techniques to generate the doppler bins (as is well known in the art) representing the relative velocity measured (radially) in the direction from the point of reflection and the receiver (antenna).

The AoA detector 330 is configured to determine the angle/position of the object or reflecting points. The AoA detector 330 may perform FFT of the samples over multiple antennas in the array to determine the angle/direction. Direction is provided as an angle measured with respect to azimuth or elevation. Accordingly, range (r), radial velocity (vᵣ) and azimuth angle (φ)/elevation angle (θ) are provided to the tracking filter 350. It may be appreciated that one of azimuth angle (φ)/elevation angle (θ) are provided instead of both. Accordingly, the azimuth angle (φ) and elevation angle (θ) are interchangeably used herein implying wherever we mention azimuth angle as measurement or state variable, it is also equally valid for the elevation angle as well. For simplicity, only Azimuth angle described or illustrated. The range detector 310, Doppler detector 320, and AoA detector 330 operate as/represent sensors configured to measuring the range (rₘ), radial velocity (vᵣ_{ₘ}) and angle (φₘ) of a reflecting object as an example. Thus, the range (rₘ), radial velocity (vᵣ_{ₘ}) and angle (φₘ) (either in azimuth or in elevation) represents the measurements that are provided to the filter 350 as the inputs. In an embodiment, the reflecting object may be required to be tracked (determine its movement/motion) accurately. For example, the noise in the measurements rₘ, vᵣ_{ₘ}, and φₘ may result with an error in determining its movement/motion. The movement or motion of an object may be represented with any specific motion model like/by its position and velocity or its position, velocity and acceleration, for example. The filter 350 provides (on path 399) more accurate determination of the motion of the object by its position, velocity and acceleration from the measurements rₘ, vᵣ_{ₘ}, and φₘ (these measurements is hereafter referred to as RVP from 180).

The tracking filter 350 is configured to provide values of a set of parameters based on the received measurements and a dynamic system model. The parameters are generally referred to as state variable while the dynamic system model provides a linear relation between the received measurements, state variables and their transition. In one embodiment, the tracking filter 350 receives the measurement values in polar coordinates and provides the estimated values of the state variables in the polar coordinate, wherein the system model representing the desired linear relation between the measurement (sensor input) and the state variable, is also represented in the polar form.

In one embodiment, the tracking filter 350 is configured to provide an estimated position (range) and velocity of the object (reflecting object) in the polar form corresponding to the received measurements. In another embodiment, filter 350 is configured to provide an estimated position (range), velocity and acceleration of the object in the polar form corresponding to the received measurements. The manner in which the tracking filter 350 may be implemented in an embodiment is further illustrated below.

FIG. 4 is a block diagram illustrating the tracking filter 350 in an embodiment. The tracking filter 400 is shown comprising memory 410, prediction unit 430, estimator (correction unit) 450, and output 470. Each element is described in further detail below.

The prediction unit 430 is shown receiving initial and/or previous state value on path 431 and 413 respectively. The initial value may be set to unity for convenience. While in operation, the previous state value may be received from the estimator 450 (through memory 410). The prediction unit 430 is configured to predict next state of the state variable from the previous state (value). As shown, the predicted state value is provided to estimator through a time delay of one unit.

The estimator (also referred to as correction unit as it updates or corrects the estimated value) 450 is shown receiving the predicted value of the state variables on path 435 and the measurements on path 451. The correction unit 450 is configured to estimate the current values of the state variable from the predicted value and the measurement. In other words, the correction unit 450 updates the predicted value to provide the current value of the state variable. The current values of the state variables are provided as output 470 of the filter 400 and are also updated in the memory 410 for prediction for the next iteration. In an embodiment, both predictor 430 and correction unit 450 are configured to receive the data in polar form and provide the predicted and estimated values in the polar form. Thus, reducing the error due to approximation and also reducing the additional computational complexity in converting any one of the inputs/outputs.

FIG. 5 illustrates the state variable provided by the estimator 450 for the measurement received in polor coordinates as in FIG. 2. The FIG. 5 depicts the motion model that comprises range r, angle θ, radial velocity r′, tangential velocity θ′, radial acceleration r″ and tangential acceleration θ″ as state variables. In the further description, as to manner in which the predictor 430 and correction unit 450 may be implemented in an embodiment is illustrated below. In that, (k) representing the variable at kth time instance, (k+1) representing the variable at the (k+1)^{th} time instance, s(.) representing the vector of state variables, and z(.) representing vector of the measurements (measurement vector).

In one embodiment, the measurement on path 451 comprises, the measurements received from RVP 180 (As in FIG. 2) and a measurement uncertainty parameters. The output 470 comprises estimated values of the state variable and the uncertainty factor (in the form of covariance) of the estimated values of the state variable. Similarly, the output of the predictor comprises the predicted values of the state variable for the next time instances and predicted uncertainty value. The manner in which, the tracking filter 400 may be implemented is further described below with references to Radar measurements received from RVP in polar coordinate. As an example of implementation of the predictor 430 and estimator 450, the description is provided with respect to the measurements received from a radar system (RVP 180) in polar coordinates and the distance, velocity and acceleration are selected as the state variables from a motion model and are in the polar form.

In one embodiment the predictor 430 is configured to provide the predicted values of state variable for(k+1)^{th} time instance from the values of state variable at k^{th} time instance using relation (when motion is model is a constant velocity (CV) model):

$${\underbrace{[ \begin{matrix}r ( k + 1 ) \\ θ ( k + 1 ) \\ {r}^{′} ( k + 1 ) \\ {θ}^{′} ( k + 1 )\end{matrix} ]}}_{s ( k + 1 )} = {\underbrace{[ \begin{matrix}1 & 0 & Δ t & 0 \\ 0 & 1 & 0 & Δ t \\ 0 & 0 & 1 & 0 \\ 0 & 0 & 0 & ( 1 - Δ t \frac{{r}^{′} ( k )}{r ( k )} )\end{matrix} ]}}_{∅ ( k ) s ( k ) Γ ( k ) n ( k )} \underbrace{[ \begin{matrix}r ( k ) \\ θ ( k ) \\ {r}^{′} ( k ) \\ {θ}^{′} ( k )\end{matrix} ]} + \underbrace{[ \begin{matrix}\frac{Δ {t}^{2}}{2} & 0 \\ 0 & 0 \\ Δ t & 0 \\ 0 & \frac{Δ t}{r ( k )}\end{matrix} ]} \underbrace{[ \begin{matrix}{r}^{″} ( k \\ {v}_{θ}^{′} ( k )\end{matrix} ]} \qquad ( 1 )$$

In an alternative embodiment the predictor 430 is configured to provide the predicted values for(k+1)^{th} time instance from the k^{th} state of the state variables using relation (when the motion model is constant acceleration (CA) model):

$${\underbrace{[ \begin{matrix}r ( k + 1 ) \\ θ ( k + 1 ) \\ {r}^{′} ( k + 1 ) \\ {θ}^{′} ( k + 1 ) \\ {r}^{″} ( k + 1 ) \\ {θ}^{″} ( k + 1 )\end{matrix} ]}}_{s ( k + 1 )} = {\underbrace{[ \begin{matrix}1 & 0 & Δ t & 0 & \frac{Δ {t}^{2}}{2} & 0 \\ 0 & 1 & 0 & Δ t & 0 & 0 \\ 0 & 0 & 1 & 0 & Δ t & 0 \\ 0 & 0 & 0 & 1 & 0 & Δ t \\ 0 & 0 & 0 & 0 & 1 & 0 \\ 0 & 0 & 0 & - Δ t \frac{{r}^{′} ( k )}{r ( k )} & 0 & ( 1 - 2 Δ t \frac{{r}^{′} ( k )}{r ( k )} )\end{matrix} ]}}_{∅ ( k ) s ( k ) Γ ( k ) n ( k )} \underbrace{[ \begin{matrix}r ( k ) \\ θ ( k ) \\ {r}^{′} ( k ) \\ {θ}^{′} ( k ) \\ {r}^{″} ( k ) \\ {θ}^{″} ( k )\end{matrix} ]} + \underbrace{[ \begin{matrix}\frac{Δ {t}^{3}}{2} & 0 \\ 0 & 0 \\ \frac{Δ {t}^{2}}{2} & 0 \\ 0 & 0 \\ Δ t & \\ & \frac{Δ t}{r ( k )}\end{matrix} ]} \underbrace{[ \begin{matrix}{r}^{′′′} ( k \\ {v}_{θ}^{″} ( k )\end{matrix} ]} \qquad ( 2 )$$

In the above relations (1) and/or (2) and in the subsequent relations and instances, the variables r(k) and r′(k) representing a motion vector in radial direction with r(k) representing the radial distance and r′(k) representing the velocity in the radial direction (radial velocity). Similarly, variables θ(k) and θ′(k) representing a motion vector in tangential direction with θ(k) representing the (azimuth or elevation as may be the case be) radial angle and θ′(k) representing the velocity in the tangential direction (tangential velocity). Correspondingly, the motion vector includes acceleration factor in the CA model, in that, r″(k) and θ″(k) representing the acceleration in radial direction and tangential direction respectively. The variable Δt representing the time difference between the two successive measurements/iterations (time difference between k and k+1 instance). The variable r′″(k) representing the jerk in radial direction and v_{θ}″(k) representing the jerk in the tangential direction.

In the CV model, the relation between the measurements and the state vector may be represented using the relation:

$$[ \begin{matrix}{r}_{m} ( k ) \\ {θ}_{m} ( k ) \\ {r}_{m}^{′} ( k )\end{matrix} ] = [ \begin{matrix}1 & 0 & 0 & 0 \\ 0 & 1 & 0 & 0 \\ 0 & 0 & 1 & 0\end{matrix} ] [ \begin{matrix}r ( k ) \\ θ ( k ) \\ {r}^{′} ( k ) \\ {θ}^{′} ( k )\end{matrix} ] + [ \begin{matrix}\tilde{r} ( k ) \\ \tilde{θ} ( k ) \\ {\tilde{r}}^{′} ( k )\end{matrix} ] \qquad ( 3 )$$

Similarly, in the CA model the relation between the measurements and the state variables may be represented using relation:

$$[ \begin{matrix}{r}_{m} ( k ) \\ {θ}_{m} ( k ) \\ {r}_{m}^{′} ( k )\end{matrix} ] = [ \begin{matrix}1 & 0 & 0 & 0 & 0 & 0 \\ 0 & 1 & 0 & 0 & 0 & 0 \\ 0 & 0 & 1 & 0 & 0 & 0\end{matrix} ] [ \begin{matrix}r ( k ) \\ θ ( k ) \\ {r}^{′} ( k ) \\ {θ}^{′} ( k ) \\ {r}^{″} ( k ) \\ {θ}^{″} ( k )\end{matrix} ] + [ \begin{matrix}\tilde{r} ( k ) \\ \tilde{θ} ( k ) \\ {\tilde{r}}^{′} ( k )\end{matrix} ] \qquad ( 4 )$$

In the above relations (3) and (4), rₘ(k) representing the measured range, θₘ(k) representing the measured angle with respect to azimuth/elevation as may be the case be and rₘ′(k) representing the radial velocity. The parameters rₘ(k), θₘ(k) and rₘ′(k) are received from RVP 180 as depicted in the FIG. 2. Similarly, the \tilde{r}(k), \tilde{θ}(k) and \tilde{r}′(k) representing the respective measurement noise with zero mean and variance σᵣ², σ_{θ}², and σ_{r′}² respectively.

In an embodiment, the correction unit 450 is configured to provide the values of state variables and its covariance. The output of the correction unit 450 therefore comprises two vectors with one containing the state variables and other being its covariance matrix. The state variable comprises the range, angle, radial velocity, radial acceleration, angular velocity and angular acceleration as in FIG. 5). Though the FIG. 5 is illustrating the velocity and angular acceleration with respect to θ (elevation angle), the velocity and angular acceleration may also be provided in respect of azimuth angle.

The correction unit 450 may be configured to provide the estimated value of the state variables as an output using the predicted values received from the predictor 430 and the measurements received from RVP 180 (the vectors 200). The correction unit 450 is implemented to update the predicted value received from the predictor 430. Accordingly, the output of the predictor 430 is provided to the correction unit 450 with a time delay of one timeunit, for example.

In one embodiment the estimator (correction unit) 450 is configured to update the predicted values of state variable that is predicted for (k+1)^{th} time instance using relation:
(5)š(k+1|k+1)=s(k+1|k)+K(k+1), wherein the K(k+1) representing the correction factor of the filter, s(k+1|k) representing the predicted state variable for k=1 instance from the kth instance and š(k+1|k+1) representing the updated state variable for k+1 instance from the predicted state variable for k+1 instance. The correction factor of the filter 400 is determined using the relation:
(6)K(k+1)=C^{s}(k+1)H(k)^{T}[C^{s}(k+1)]⁻¹, wherein the C^{s}(k+1) representing the predicted covariance of the predicted state variables s(k+1) and H(k)^{T} representing the transpose of the measurement matrix as noted in the relation (3) and (4). That is the measurement matrix H(k) may be one of

$$H ( k ) = [ \begin{matrix}1 & 0 & 0 & 0 \\ 0 & 1 & 0 & 0 \\ 0 & 0 & 1 & 0\end{matrix} ] or [ \begin{matrix}1 & 0 & 0 & 0 & 0 & 0 \\ 0 & 1 & 0 & 0 & 0 & 0 \\ 0 & 0 & 1 & 0 & 0 & 0\end{matrix} ]$$

for CV and CA model respectively.
The covariance C^{s}(k+1) may be determined by the predictor 430 from the prior covariance C^{s}(k). The C^{s}(k+1) may be predicted using the relation: C^{s}(k+1)=Ø(k) C^{s}(k) Ø(k) T+Γ(k)C⁽ⁿ⁾(k)Γ(k)^{T}.

The estimator 450 may estimate/update the covariance C^{s}(k+1) using the relation: C^{s}(k+1)|(k+1)=H(k) C^{s}(k+1)H(k)^{T}+C^{w}(k), wherein C^{s}(k+1)|(k+1) representing updated covariance and the C⁽ⁿ⁾(k) and C^{w}(k) representing process noise and measurement noise respectively. Due to the estimator 450 and 430, none of the state variables measurements are required to be converted to other domain of representation and at the same time the filter 400 is implemented with simpler linear relation between them thereby simplifying the computational processes.

FIGS. 6A and 6B illustrates the performance of the filter 400 in an example embodiment. In that, FIGS. 6A and 6B respectively are linear and non linear trajectories of the object mapped against ground truth. The ground truth points are marked “X”, the measurements are marked “⋅”(Red in colour), the corrected values from the correction unit 400 are marked with dots for constant velocity model and with dashed lines for constant acceleration model. As may be seen, the corrected values provided by the filter 400 are matching with the ground truth as against the measurement.

While various embodiments of the present disclosure have been described above, it should be understood that they have been presented by way of example only, and not limitation. Thus, the breadth and scope of the present disclosure should not be limited by any of the above-discussed embodiments but should be defined only in accordance with the following claims and their equivalents.

What is claimed is:

1. A millimeter wave signal processing system comprising:
a millimeter wave signal carrying a set of data represented in a polar form;
a tracking filter configured to provide a set of variables in the polar form that is determined from the set of data and a system model that maintain linear relation with the set of variable and the set of data.

2. The millimeter wave signal processing system of claim 1, wherein the millimeter wave is a radar signal reflected from an object, the set of data is a measurement of an object in motion comprising a range, an angle, and a radial velocity, and the set of variables comprising a range, an angle, a radial velocity, and tangential velocity.

3. The millimeter wave signal processing system of claim 2, wherein the set of variables further comprising a radial acceleration and a tangential acceleration.

4. The millimeter wave signal processing system of claim 3, wherein the system model comprising a state transition vector and measurement vector.

5. The millimeter wave signal processing system of claim 4, further comprising a predictor and an estimator that are configured to predict a next set of values from a previous set of values of the set of variables using relation:
$$[ \begin{matrix}r ( k + 1 ) \\ θ ( k + 1 ) \\ {r}^{′} ( k + 1 ) \\ {θ}^{′} ( k + 1 )\end{matrix} ] = [ \begin{matrix}1 & 0 & Δ t & 0 \\ 0 & 1 & 0 & Δ t \\ 0 & 0 & 1 & 0 \\ 0 & 0 & 0 & ( 1 - Δ t \frac{{r}^{′} ( k )}{r ( k )} )\end{matrix} ] [ \begin{matrix}r ( k ) \\ θ ( k ) \\ {r}^{′} ( k ) \\ {θ}^{′} ( k )\end{matrix} ] + [ \begin{matrix}\frac{Δ {t}^{2}}{2} & 0 \\ 0 & 0 \\ Δ t & 0 \\ 0 & \frac{Δ t}{r ( k )}\end{matrix} ] [ \begin{matrix}{r}^{″} ( k \\ {v}_{θ}^{′} ( k )\end{matrix} ]$$
wherein r(k) and r′(k) representing a motion vector in radial direction with r(k) representing the radial distance and r′(k) representing the velocity in the radial direction (radial velocity), θ(k) and θ′(k) representing a motion vector in tangential direction with θ(k) representing the azimuth radial angle and θ′(k) representing the velocity in the tangential direction (tangential velocity), Δt representing the time difference between the next and previous time instances.

6. The millimeter wave signal processing system of claim 5, where in the estimator is configured to update the predicted value using relation:
š(k+1|k+1)=s(k+1)+K(k+1),
wherein the K(k+1) representing the gain of the tracking filter.

7. A method, system, and apparatus for radar receiver system comprising one or more features described in the specifications and drawings.
